(19) United States
(12) Patent Application Publication
(10) Pub. No.: US 2024/0239071 A1
(43) Pub. Date: Jul. 18, 2024

(54) MOLDING SUBSIDIARY MATERIAL AND METHOD OF PRODUCING SAME

(71) Applicant: Ohtsuka Sangyo Material Co., Ltd, Nagahama-shi (JP)

(72) Inventors: Motoyoshi OHTSUKA, Nagahama-shi (JP); Hajime SAKAI, Nagahama-shi (JP)

(73) Assignee: Ohtsuka Sangyo Material Co., Ltd, Nagahama-shi (JP)

(21) Appl. No.: 18/513,074

(22) Filed: Nov. 17, 2023

(30) Foreign Application Priority Data
Jan. 12, 2023 (JP) 2023-003312

(51) Int. Cl. B29D 99/00; B32B 3/26; B32B 5/02; B32B 5/16; B32B 5/24; B32B 7/12; B32B 27/12

(52) U.S. Cl. CPC B29D 99/0092; B32B 3/266; B32B 5/022; B32B 5/16; B32B 5/245; B32B 7/12; B32B 27/12; B32B 2262/0276; B32B 2307/208; B32B 2605/003

(57) ABSTRACT

[Problem to be solved] An object is to provide a method of efficiently producing even a subsidiary material having a complex shape corresponding to a resin body.

[Solution] The production method of the present invention includes, for example, a molding step of obtaining a molded material (m1) in which an irregular-shaped molded portion (10) is provided on a part of a flat sheet material by molding and an overlap-bonding step of overlap-bonding a notched portion (21) provided on an outer peripheral side of the molded material to obtain an overlap-bonded and molded material (m4) in which at least a part of the outer peripheral side is curved. Thus, a molding subsidiary material (M) is obtained which includes the overlap-bonded and molded material and is integrated with a resin body (R). The sheet material is made, for example, of a nonwoven fabric. The resin body is made, for example, of a foamed resin. When the resin body is provided with an inner cavity (air passage), for example, a through-hole corresponding to the inner cavity is formed in the molded portion. By separating the molding step and the overlap-bonding step, even a complex-shaped subsidiary material can be produced at low cost.

### TECHNICAL FIELD

The present invention relates to a method of producing a molding subsidiary material (simply referred to as a “subsidiary material” as appropriate) that is integrated with a resin body, and relates also to relevant techniques.

### BACKGROUND ART

A soft resin body (e.g., a foamed resin body such as urethane foam) constituting a pad, cushion, or the like is covered with a nonwoven fabric or the like (subsidiary material) that is integrated with at least a part of the surface of the soft resin body. The subsidiary material contributes to ensuring the strength, wear resistance, shape retention, etc. of the resin body, suppressing abnormal noise generated between the resin body and a frame or the like, etc. Representative examples of such a resin body integrated with a subsidiary material include cushion materials for seats used in moving bodies (such as automobiles and railway vehicles).

Meanwhile, the seats installed in automobiles are becoming more and more multifunctional; for example, they have built-in side airbag devices, ventilation devices, etc., repulsive force reduction functions are added for protection of occupants by sinking the occupants' bodies into the seats in the event of a collision or the like, and other similar measures are taken. In response to such circumstances, complex three-dimensional shapes (tridimensional shapes) are now required not only for cushion materials for seats but also for subsidiary materials. Descriptions related to these can be found, for example, in the following patent documents.

### PRIOR ART DOCUMENTS

### Patent Documents

[Patent Document 1] JP2007-84039A
[Patent Document 2] JP2018-76044A
[Patent Document 3] JP2021-146805A
[Patent Document 4] JPH5-130923A
[Patent Document 5] JP2006-1147A
[Patent Document 6] JP2005-238675A
[Patent Document 7] JP2015-027739A
[Patent Document 8] JP2014-094623A
[Patent Document 9] JP2012-126291A

### SUMMARY OF INVENTION

### Problem to be Solved by Invention

All of Patent Documents 1 to 3 merely describe the shape and structure of a cushion material (including a pad material) itself. In other words, nothing in these documents specifically describes or suggests the structure, production method, etc. of a nonwoven fabric or the like (subsidiary material) that is integrated with the cushion material.

Patent Document 4 proposes a reinforcing fabric (subsidiary material) for a cushion material obtained through molding the entire nonwoven fabric and cutting (trimming) its outer periphery. In this case, a different mold is required for each type (one design) of reinforcing fabric, which may increase the production cost for the reinforcing fabric, the storage cost for the mold, etc. Patent Document 5 proposes a reinforcing fabric (subsidiary material) for a pad obtained by sewing a notch provided on the outer peripheral side of a flat nonwoven fabric. It is difficult to produce a reinforcing fabric having a complicated tridimensional shape only by sewing.

Patent Document 6 proposes providing irregularities having different depths in the thermally pressure-bonded portion of a nonwoven fabric. The irregularities are provided to suppress leakage of the urethane foam integrated with the subsidiary material to the outside. Such irregularities are formed by embossing and are very small with an area of 0.5 to 5 mm² per one irregularity and a minimum interval of 1 to 5 mm.

Patent Document 7 merely describes a feature that a magnetic tape is attached to the outer peripheral edge side of a molded backing material.

Patent Document 8 describes a feature that a seat cushion pad having a ventilation path and a backing material are integrally molded, but nothing in the document describes the molding, sewing, or the like of the backing material itself.

Patent Document 9 is silent about the molding of a subsidiary material and merely describes providing a notch on the outer peripheral edge side.

The present invention has been made in view of such circumstances, and objects of the present invention include providing a novel method of producing a molding subsidiary material and providing relevant techniques.

### Solution to Problem

As a result of intensive studies to achieve the above objects, the present inventors have come up with an idea of separating the molding of a part of a sheet material and the overlap-bonding of a notch provided on the outer peripheral side of the sheet material and have embodied this idea. Developing this achievement, the present inventors have accomplished the present invention as will be described hereinafter.

### «Method of Producing Molding Subsidiary Material»

(1) The present invention is, for example, a method of producing a molding subsidiary material, comprising: a molding step of obtaining a molded material in which an irregular-shaped molded portion is provided on a part of a flat sheet material by molding; and an overlap-bonding step of overlap-bonding a notched portion provided on an outer peripheral side of the molded material to obtain an overlap-bonded and molded material in which at least a part of the outer peripheral side is curved, wherein the molding subsidiary material comprises the overlap-bonded and molded material and is integrated with a resin body.

(2) The present invention may also be a method of producing a molding subsidiary material, comprising: an overlap-bonding step of overlap-bonding a notched portion provided on an outer peripheral side of a flat sheet material to obtain an overlap-bonded material in which at least a part of the outer peripheral side is curved; and a molding step of obtaining an overlap-bonded and molded material in which an irregular-shaped molded portion is provided on a part of the overlap-bonded material by molding, wherein the molding subsidiary material comprises the overlap-bonded and molded material and is integrated with a resin body.

(3) According to the present invention, it is possible to efficiently produce subsidiary materials having a tridimensional (three-dimensional) shape, and the production cost and the unit price can be reduced. The reason for this is considered as follows.

In the molding step, a region with complex shape that require a desired accuracy is molded. There is no need to mold the entire sheet material, and only a portion of the sheet material is molded, so the mold can be reduced in size and commonly used. This can reduce the mold production cost (including mold modification cost, etc.), storage cost, and the like and accordingly reduce the production cost for the subsidiary material. The reason why it is possible to use a common mold is that even when the overall shape of the subsidiary material differs (i.e., the subsidiary material has a different design), the shape of the molded portion itself is often the same (common).

In the overlap-bonding step, edges of the notched portion which is provided on the outer peripheral side and is not molded are overlapped and bonded. This allows the outer peripheral region, which does not require a complex shape or high accuracy unlike the molded portion, to be formed efficiently or at low cost.

Thus, the molding step and the overlap-bonding step function in a mutually complementary manner thereby to allow even a subsidiary material having a complex shape to be efficiently produced, and the production cost and unit price of the subsidiary material can be reduced in whole.

(4) Meanwhile, the molded material before the overlap-bonding step has an irregular shape only in the molded portion, and the remaining portion is in the form of a flat sheet, so two or more molded materials may often be in a state of being overlapped (stacked). In such a case, it is possible to process (notch, cut, etc.), transport, store, or perform other similar treatment on the two or more molded materials at once. Such circumstances may also apply to the overlap-bonded material before the molding step. According to the present invention, therefore, the production cost and unit price of the subsidiary material can be reduced even when the molding step and the overlap-bonding step are performed at different locations (different factories, countries, etc.).

### «Molding Subsidiary Material»

The present invention is also perceived as a molding subsidiary material itself. For example, the present invention may be a molding subsidiary material comprising: an irregular-shaped molded portion; and an overlap-bonded portion that is formed by overlap-bonding of a notched portion and curves at least a part on an outer peripheral side, wherein the molding subsidiary material is integrated with a resin body. The molding subsidiary material is also called a reinforcing cloth, a lining material, a covering material, a molding base cloth, etc., depending on its function or the like.

### «Composite Material, Etc.»

The present invention is also perceived as a composite material. For example, the present invention may be a composite material comprising: the above-described molding subsidiary material; and a resin body integrated with the molding subsidiary material.

The present invention is also perceived as a method of producing such a composite material. For example, the present invention may be a method of producing a composite material, comprising: a preparation step of disposing a molding subsidiary material on the inner wall surface of a cavity; and a resin molding step of (foaming) molding a resin in the cavity.

Furthermore, the present invention may also be perceived as various products (members) each having the above-described composite material. Such a product may be an article in which the composite material is covered with a skin material or the like (e.g., a seat) or may also be an article in which at least a part of the composite material is exposed (e.g., a sound-absorbing material).

### BRIEF DESCRIPTION OF DRAWINGS

FIG. 1 is a schematic cross-sectional view exemplifying a process of molding a sheet material.

FIG. 2 is a perspective view exemplifying a molded sheet material (molded material).

FIG. 3A is a perspective view exemplifying the back side (concave side) of a molded material whose outer peripheral side is trimmed.

FIG. 3B is a perspective view exemplifying the front side (convex side) of the molded material.

FIG. 4 is a perspective view exemplifying a molded material having through-holes provided in the molded portion.

FIG. 5 is a perspective view exemplifying an overlap-bonded and molded material whose notched portions provided on the outer peripheral side are sewed.

FIG. 6 is a perspective view exemplifying the overlap-bonded and molded material (subsidiary material) in which magnetic materials are disposed on the outer peripheral side.

FIG. 7 is a schematic cross-sectional view exemplifying a process in which a foamed resin body is integrated with the subsidiary material.

FIG. 8A is a perspective view exemplifying the back side of a cushion material in which a subsidiary material and a foamed resin body are integrated.

FIG. 8B is a perspective view exemplifying the front side of the cushion material.

### EMBODIMENTS FOR CARRYING OUT THE INVENTION

One or more features freely selected from the present specification can be added to the above-described features of the present invention. The content described in the present specification can apply not only to the production method of the present invention but also to products (such as subsidiary materials and composite materials) as appropriate. Features regarding a method can also be features regarding a product. Which embodiment is the best or not is different in accordance with objectives, required performance, and other factors.

### «Sheet Material»

(1) The sheet material used as a raw material is usually made of a flat and flexible soft material. The sheet material may be a single layer or a multilayer. The sheet material may be homogeneous over the entire region, or the thickness, material, layer structure, etc. may differ from region to region. The sheet material may preferably have a thickness or density (basis weight) that is sufficient to prevent penetration of the impregnated resin into the back surface at least before molding.

At least the outer peripheral side of the sheet material (including the molded material or the overlap-bonded material) is preferably cut (cut off, trimmed, etc.) into a desired shape (cutting step). The cutting may be performed in a state in which two or more (a large number of) sheets are stacked. The cutting may be performed by mechanical shearing with a cutting blade (punching blade), melting with a heating blade, laser irradiation, or the like, or cutting off with scissors or the like.

The cutting is preferably performed at least once before the molding step, after the molding step and before the overlap-bonding step, or after the overlap-bonding step. It is efficient if the cutting is performed together with the formation of notched portions and before the overlap-bonding step. In the case of a sheet material before processing, the sheet material may be cut into a developed shape that takes into consideration the final shape of the subsidiary material. Further cutting (trimming) may be added after the molding step or the overlap-bonding step.

(2) The sheet material preferably includes at least a nonwoven fabric (layer). The nonwoven fabric provided on the opposite side (back side) of the resin body can suppress abnormal noise caused by contact between the composite material and another member (such as a frame). The nonwoven fabric provided on the resin body side (front side) is impregnated with a resin (in particular, a foamed resin) to bring the subsidiary material into close contact with the resin body.

The nonwoven fabric is a thin sheet-like fabric obtained by entangling (intertwining) or coupling (bonding) a large number of fibers or performing other similar treatment on such fibers. The form and production method of the nonwoven fabric, the type/composition of fibers, the state of entanglement and coupling between fibers, etc. are selected as appropriate.

Fibers that constitute the nonwoven fabric are usually made of chemical fibers, but may contain natural fibers (such as cotton, wool, and linen), carbon fibers, metal fibers, etc. The length of fibers is not limited; for example, they may be long fibers, short fibers, or a mixture thereof. The chemical fibers may be polyester, polyamide, polyethylene, polypropylene, or acrylic fibers, other similar fibers, or regenerated fibers such as rayon fibers.

The nonwoven fabric may be made of mixed fibers obtained, for example, by mixing low-melting fibers and high-melting fibers having relatively different softening points or melting points. When such a nonwoven fabric is heated, the low-melting fibers preferentially soften or melt and harden or solidify in a state of being entangled with the high-melting fibers. A sheet material made of such a nonwoven fabric is readily fused (thermally bonded) and therefore is excellent in the shape retention when heat-molded and the pressure-bonding ability when heated and overlap-bonded.

The sheet material may be made of only a single type of nonwoven fabric, may be a laminate of two or more types of nonwoven fabrics, or may have a material other than the nonwoven fabric. The sheet material may be preliminarily cut into predetermined units (shapes) and supplied to the molding step or the overlap-bonding step or may also be supplied continuously (e.g., in a roll form).

### «Molding Step»

The molding step includes forming an irregular-shaped molded portion on a part of a flat sheet material by molding. The mold may be any of a metal mold, a resin mold, and other similar mold. Molding is usually performed by pressing the sheet material with an upper die and a lower die. The temperature, pressure, time, etc. of the molding step are appropriately adjusted in consideration of the material properties, moldability, shape retention after molding, etc. of the sheet material. The molding step may be cold molding, but if warm molding (hot molding) is performed, the shape of the molded portion is readily stabilized or is highly accurate.

When the sheet material is made of a nonwoven fabric obtained by mixing low-melting fibers and high-melting fibers, warm molding may be performed by adjusting the temperature of the sheet material or mold to a temperature that is not lower than the temperature at which at least a part of the low-melting fibers melts, but is lower than the temperature at which the high-melting fibers do not melt.

### «Overlap-Bonding Step»

Through the overlap-bonding step, an overlap-bonded portion is formed in which edges of a notched portion provided on the outer peripheral side are overlapped. The overlap-bonded portion allows at least a part of the outer peripheral side of the sheet material to be put into a curved state. When the overlap-bonding step is performed before the molding step, an overlap-bonded material is obtained, while when the overlap-bonding step is performed after the molding step, an overlap-bonded and molded material is obtained.

The overlap-bonding step is performed, for example, by sewing, pressure bonding, gluing, or fastening a notched portion or performing other similar treatment on the notched portion. The curved form created on the outer peripheral side can be adjusted by changing the shape of the notched portion, the length and width of the overlap-bonded portion, etc. Pressure bonding of the notched portion may be, for example, thermal pressure bonding in which sides of the notch overlapped are welded to each other. Fastening of the notched portion may be performed, for example, by engaging sides of the notch with each other using a stapler, a pin, or the like. A staple or a pin may be used as a magnetic material, which will be described below.

### «Magnetic Material»

The subsidiary material is usually integrally molded (insert-molded) with a resin body in a state of being held on the inner wall of a cavity. There may be various methods of holding the subsidiary material. For example, the subsidiary material may be held by engaging a hole provided on the outer peripheral side of the subsidiary material to a protrusion provided on the inner wall of the cavity. When the mold for the resin body is made of a magnetic material (such as steel material), the subsidiary material may be held by being magnetically attached to the inner wall of the cavity. Such magnetic materials are disposed, for example, at least on the outer peripheral side of the subsidiary material (molded material or overlap-bonded and molded material), but may also be provided at other sites. The magnetic material may be a soft magnetic material or a hard magnetic material (permanent magnet). Provided that the mold for the resin body is magnetized, the subsidiary material side may be a soft magnetic material.

### «Subsidiary Material/Composite Material»

(1) The subsidiary material includes an irregular-shaped molded portion and an overlap-bonded portion in which edges of a notched portion are overlap-bonded, and this subsidiary material is integrated with a resin body to form a composite material.

The molded portion and the overlap-bonded portion may be in any form, provided that they are suitable for the specifications of the composite material. For example, when the resin body is provided with an internal cavity, the molded portion may be preferably provided with a through-hole or slit (cut) corresponding to the internal cavity. Examples of the internal cavity include ventilation passages used for air conditioning or the like, passages (such as insertion passages, fitting passages, through-passages, and introduction passages) for other members (such as piping, wiring, cables, sensors, equipment, headrest supports, and shafts of levers and handles), and various storage chambers (storage spaces for electronic equipment, electrical equipment, side air-bags, etc.).

The through-hole or slit (referred to as a “through-hole or the like”) may be formed at any stage before the molding step, before the overlap-bonding step, after the molding step, or after the overlap-bonding step. The through-hole or the like may be formed (drilled or the like) at once in a state in which two or more sheets are stacked. Additionally or alternatively, the through-hole or the like may be completed through providing a shape, notch, or the like that becomes a part of the through-hole or the like and then performing cutting off or the like for the remaining portion (after the molding step or overlap-bonding step for the sheet material).

The overlap-bonded portion is formed by overlapping the opposing end edges of a notched portion and bonding the overlapping portions. The overlap-bonded portion may be preferably formed to such an extent that the integrally molded resin raw material does not leak out (penetrate). The shape of the notched portion to be overlap-bonded is not limited, but may be, for example, wedge-shaped (V-shaped), slit-shaped (elongated rectangular shape), arc-shaped, U-shaped, or the like.

(2) The composite material is used, for example, as a cushion material, a protective material for wiring (electric wire), piping, or the like, a sound-absorbing material, a shock-absorbing material, a filter material, a heat insulating material, or the like. The composite material may be used for a component (such as a seat or interior part) of a moving body involving vibration and swing (such as an automobile, train, or airplane) as well as for furniture (such as a seat or sofa), bedding (such as a bed), or the like in a building.

The region and arrangement for providing the molded portion (irregular shape), the form of irregular shape, etc. are various. One or more molded portions are provided, for example, near the center, near the right and left sides, near the top and bottom, etc. of the sheet material excluding the outer peripheral edge portion. The molded portion of the subsidiary material is usually provided along the irregular shape of the resin body. The irregular shape of the resin body is sized to ensure the required specifications (functions). Accordingly, the molded portion of the subsidiary material also has the same size (such as a dimension or area) as the irregular shape of the resin body.

The convex portion or concave portion of the subsidiary material may have a width (minimum length on the short side) of 1-50 cm, 2-30 cm, 3-20 cm, or 5-10 cm, for example. Their length (longitudinal length) may be, for example, 5-200 cm, 10-100 cm, or 15-50 cm. The area defined by the convex portion or concave portion (convex area or concave area) may be, for example, 1-1000 cm², 4-500 cm², or 10-200 cm².

The molded portion is formed by pressing a sheet material (original fabric). The thickness of the sheet material (such as nonwoven fabric) is therefore reduced after molding. The thickness of the molded portion is, for example, 10-90%, 20-80%, or 30-70% of the thickness of the sheet material before molding. The thickness of the molded portion made of nonwoven fabric is, for example, 25-75%, 35-65%, or 40-60% of the thickness of the nonwoven fabric before molding.

Unless otherwise stated, a numerical range “a-B” as referred to in the present specification means a or more and B or less and includes the lower limit a and the upper limit B. Any numerical value included in various numerical values or numerical ranges described in the present specification may be selected or extracted as a new lower or upper limit, and any numerical range such as “a-b” can thereby be newly provided using such a new lower or upper limit. A range of “α-β cm” means a range from a cm to ß cm. The same applies to other unit systems (such as cm²).

### EXAMPLES

The present invention will be described in more detail while exemplifying a subsidiary material used for a cushion material (composite material) attached to an automobile seat having an air-conditioning function.

### «Molding»

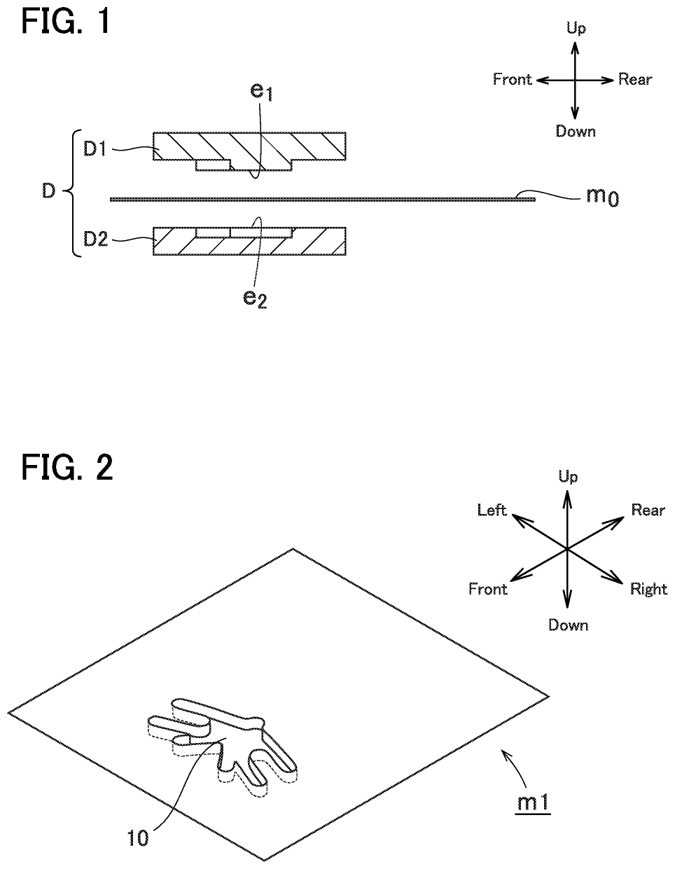

(1) As illustrated in FIG. 1, a sheet material m0 was heat-molded using a mold D. The mold D includes an upper die D1 and a lower die D2. The upper die D1 and the lower die D2 are molds each having a built-in heater (not illustrated). The upper die D1 and the lower die D2 have a convex portion e1 and a concave portion e2, respectively, on opposing molding surface sides. The convex portion e1 and the concave portion e2 each have a shape corresponding to an irregular-shaped molded portion 10 provided on the sheet material m0 along the irregular shape of a resin body (foamed resin body R). The width of the concave portion and convex portion of the molded portion 10 is about 2 cm, and the area defined by each of the concave portion and the convex portion is about 20 cm².

In this example, for descriptive purposes, the direction indicated by an arrow in each figure is the up-down direction, the right-left direction, or the front-back direction. Regarding the members or sites that have already been described, the same reference numerals are used as appropriate to omit redundant description.

The sheet material m0 is made of a single layer of nonwoven fabric having an approximately uniform thickness. The nonwoven fabric is made, for example, of a mixture of two types of chemical fibers having different melting points. Specifically, the nonwoven fabric is made of mixed fibers of low-melting polyester fibers (e.g., a melting point/softening point (TL) of about 50-200° C.) and high-melting polyester fibers (e.g., a melting point/softening point (TH) of about 200-300° C.). The mixing ratio of the low-melting polyester fibers is, for example, about 10-70 mass % with respect to the whole (total).

The sheet material m0 is obtained by preliminarily cutting a nonwoven fabric wound as a roll into a desired shape (e.g., a rectangular shape).

(2) Molding of the sheet material m0 using the mold D is performed as follows. First, the upper die D1 and the lower die D2 are heated to a desired molding temperature using the built-in heaters. When the sheet material m0 is a nonwoven fabric made of the above-described mixed fibers, for example, the molding temperature (T) may satisfy TL≤T<TH. At this time, the softened or melted low-melting polyester fibers become entangled with the high-melting polyester fibers and solidify, and the moldability, shape retention, etc. can thereby be improved.

Then, the sheet material m0 is inserted between the heated upper die D1 and lower die D2, and the molding region of the sheet material m0 is located between a convex portion e1 and a concave portion e2. The molding region of the sheet material m0 is press-molded by the upper die D1 and the lower die D2. After retention for a predetermined time, the sheet material m0 is taken out from the mold D. Thus, as illustrated in FIG. 2, a molded material m1 is obtained in which the complex irregular-shaped molded portion 10 is formed with high accuracy only in a predetermined region of the flat nonwoven fabric. In the prototype actual example, the thickness (t) of the nonwoven fabric of the molded portion 10 was about 50% with respect to the thickness (to) of the flat nonwoven fabric (original fabric) before molding (t/to was about 0.5). The unmolded portion almost maintained its original fabric state and was bulky, soft, and thick.

### «Cutting»

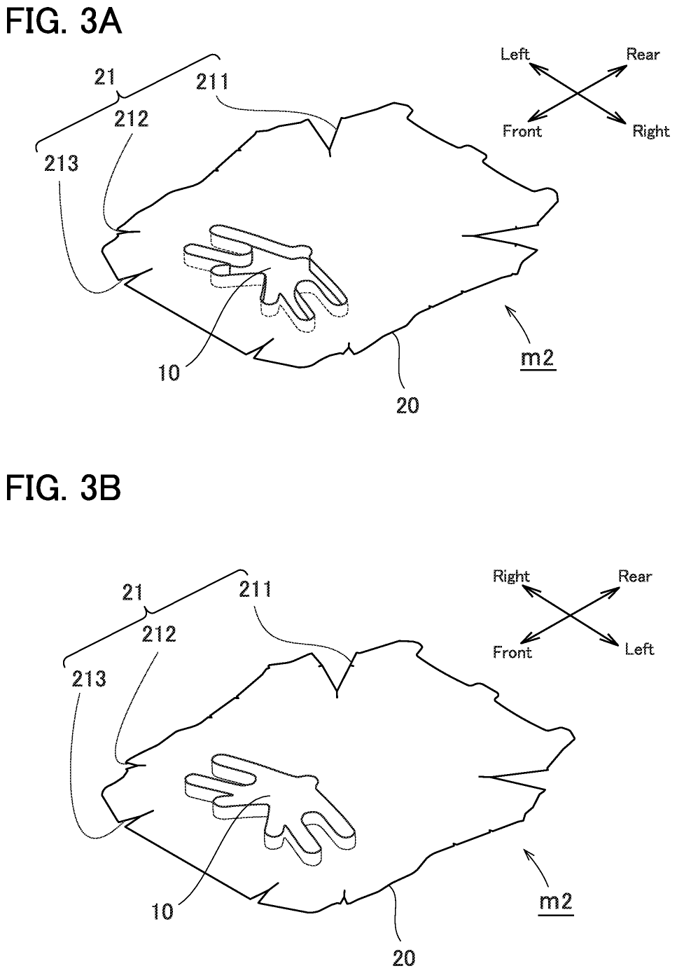

As illustrated in FIGS. 3A and 3B (both are collectively referred to as “FIG. 3”), a molded material m2 is obtained by cutting the outer peripheral side of the molded material m1 into a desired shape (cutting, trimming, or the like) (cutting step). FIG. 3A illustrates the concave side of the molded material m2 (this is the back side), and FIG. 3B illustrates the convex side of the molded material m2 (this is the front side).

An outer peripheral edge 20 of the molded material m2 has a shape corresponding to the foamed resin body R to be integrally molded, which will be described later. Approximately V-shaped notched portions 211, 212, and 213 (these are collectively referred to as “notched portions 21”) are formed symmetrically on the outer peripheral side of the molded material m2. The outer peripheral side of the molded material m2 can be cut, for example, by shearing with a Thomson blade or the like or by melting with a laser or the like in a state in which two or more molded materials m1 are stacked.

### «Drilling»

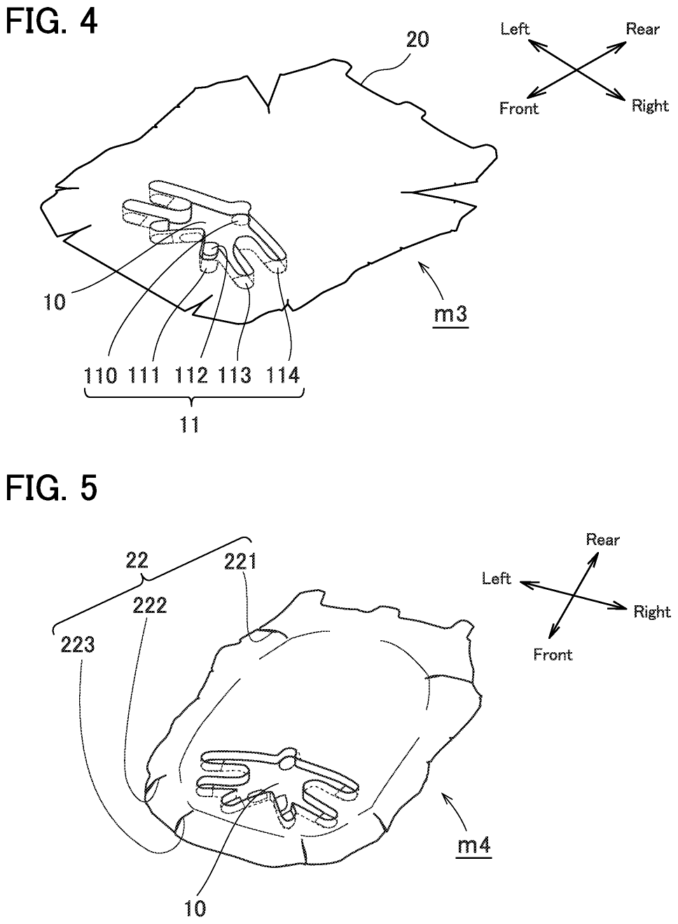

As illustrated in FIG. 4, through-holes 110, 111, 112, 113, and 114 (these are collectively referred to as “through-holes 11”) are provided at predetermined positions within the molded portion 10 (drilling step). The through-holes 111, 112, 113, and 114 are formed within the molded portion 10 in an approximately symmetrical fashion. A molded material m3 is thus obtained.

Drilling of the through-holes 11 can be performed, for example, also in a state in which two or more molded materials m2 are stacked. Instead of drilling, cuts may be preliminarily made at positions corresponding to the through-holes 11 in the sheet material m0. The cuts may each be a complete through-hole or a part of a hole. In the latter case, the through-holes are completed by manually cutting off the remaining pieces or by performing other similar operation.

### «Overlap-Bonding»

As illustrated in FIG. 5, the cut edges of the notched portions 211, 212, and 213 formed on the outer peripheral side of the molded material m2 (molded material m3) are overlapped and sewn together, and sewn overlap-bonded portions 221, 222, and 223 (these are collectively referred to as “overlap-bonded portions 22”) are formed symmetrically (overlap-bonding step). Thus, an overlap-bonded and molded material m4 whose outer peripheral side is gently bent toward the front side is obtained. The overlap-bonded portions 22 may also be formed by thermal bonding, gluing, or the like of the notched portions 21.

### «Magnetic Materials»

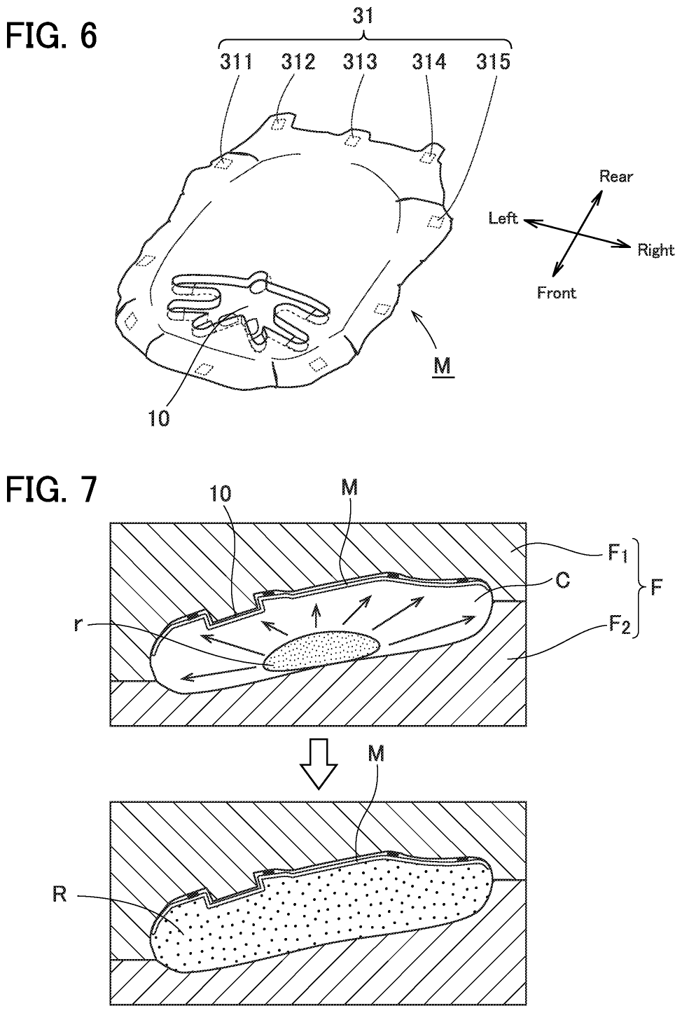

As illustrated in FIG. 6, magnetic materials 311, 312, 313, 314, and 315 (collectively referred to as “magnetic materials 31”) made of plastic magnet pieces, which are permanent magnets, are disposed on the back-surface outer peripheral side of the overlap-bonded and molded material m4 in an approximately front-back symmetrical fashion. The magnetic materials 31 are attached to the back surface of the overlap-bonded and molded material m4 (the opposite surface to the foamed resin body R to be integrated) using a double-sided pressure-sensitive adhesive tape or an adhesive. Thus, a subsidiary material M to be integrated with the foamed resin body R is obtained.

### «Integral Molding»

As illustrated in FIG. 7, the subsidiary material M is magnetically attached to a predetermined position on the upper wall surface (molding surface of a resin mold F1) of a cavity C formed between resin molds F1 and F2 (both are collectively referred to as “resin molds F”). A resin raw material r injected into the cavity C is heated and foamed. The resin raw material r is, for example, a composition that contains urethane and a foaming agent.

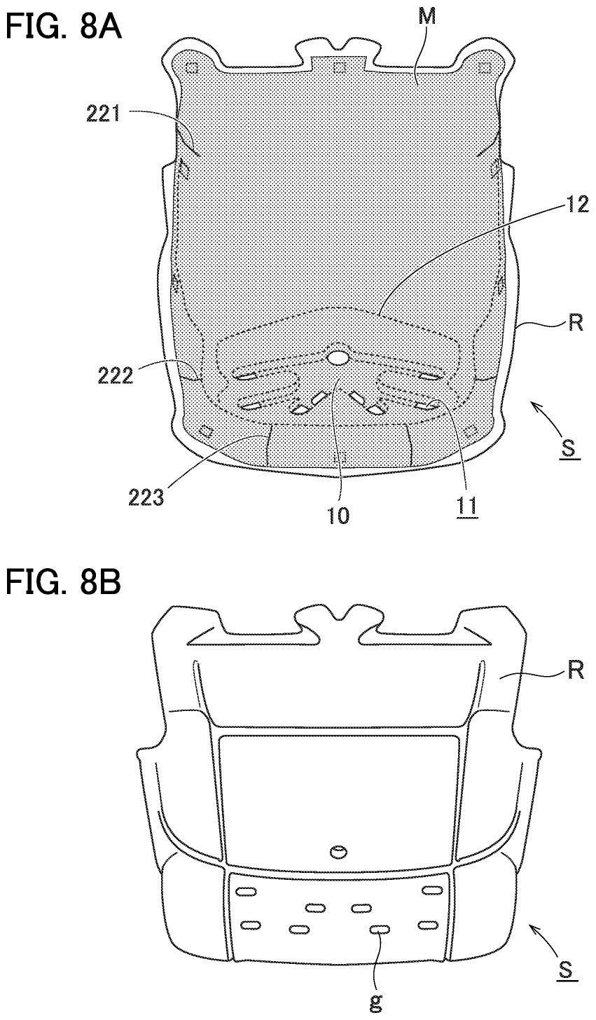

After heating and foaming, as illustrated in FIGS. 8A and 8B (both are collectively referred to as “FIG. 8”), a cushion material S (composite material) is obtained in which the subsidiary material M is integrated (insert-molded) with the foamed resin body R (e.g., urethane foam). FIG. 8A illustrates the back surface side of the cushion material S, and FIG. 8B illustrates the front surface side (seating surface side) of the cushion material S.

Meanwhile, in the prototype actual example, no exudation of the foamed resin (such as urethane foam) was observed from the molded portion 10 or the surrounding non-molded portion during the integral molding. This is considered to be because the molded portion 10 was in a state in which the desired shape was sufficiently ensured due to fusion of some fibers of the nonwoven fabric and its outer peripheral surface was held (supported) in close contact (fit) with the wall surface of the cavity C of the resin mold F. On the other hand, the non-molded portion other than the molded portion 10 has sufficient thickness because of substantially being the original fabric. It is therefore considered that the foamed resin (such as urethane foam) impregnated into the nonwoven fabric of the non-molded portion, but did not seep out through the thick nonwoven fabric.

The foamed resin body R is formed with a plurality of ventilation passages g (inner cavities) corresponding to the through-holes 11 of the subsidiary material M. Cold air or warm air introduced from the piping of an air conditioner attached to an annular portion 12 surrounding the molded portion 10 passes through the through-holes 11 from the back surface side of the cushion material S, passes through the ventilation passages g, and is discharged to the seat surface of the automobile seat.

This example has been exemplified for the case of producing the subsidiary material by performing the overlap-bonding step after the molding step, but of course, the subsidiary material may be produced by performing the molding step after the overlap-bonding step.

### DESCRIPTION OF REFERENCE NUMERALS

10 Molded portion
11 Through-hole
21 Notched portion
22 Overlap-bonded portion
31 Magnetic material
m0 Sheet material
m1-m3 Molded material
m4 Overlap-bonded and molded material
M Subsidiary material
R Foamed resin body
S Cushion material (composite material)

1. A method of producing a molding subsidiary material, comprising:
a molding step of obtaining a molded material in which an irregular-shaped molded portion is provided on a part of a flat sheet material by molding; and
an overlap-bonding step of overlap-bonding a notched portion provided on an outer peripheral side of the molded material to obtain an overlap-bonded and molded material in which at least a part of the outer peripheral side is curved,
wherein the molding subsidiary material comprises the overlap-bonded and molded material and is integrated with a resin body.

2. The method of producing a molding subsidiary material according to claim 1, wherein at least an outer peripheral side of the sheet material is cut into a desired shape before the molding step.

3. The method of producing a molding subsidiary material according to claim 1, wherein at least the outer peripheral side of the molded material is cut into a desired shape before the overlap-bonding step.

4. The method of producing a molding subsidiary material according claim 1, wherein the overlap-bonding is performed by sewing, pressure bonding, gluing, or fastening.

5. The method of producing a molding subsidiary material according to claim 1, wherein the overlap-bonded and molded material is provided with a magnetic material at least on an outer peripheral side.

6. The method of producing a molding subsidiary material according to claim 1, wherein the sheet material includes at least a nonwoven fabric.

7. The method of producing a molding subsidiary material according to claim 1, wherein the molded portion is formed with a through-hole or slit corresponding to an inner cavity provided in the resin body.

8. The method of producing a molding subsidiary material according to claim 7, wherein the inner cavity is a ventilation passage.

9. A method of producing a molding subsidiary material, comprising:
an overlap-bonding step of overlap-bonding a notched portion provided on an outer peripheral side of a flat sheet material to obtain an overlap-bonded material in which at least a part of the outer peripheral side is curved; and
a molding step of obtaining an overlap-bonded and molded material in which an irregular-shaped molded portion is provided on a part of the overlap-bonded material by molding,
wherein the molding subsidiary material comprises the overlap-bonded and molded material and is integrated with a resin body.

10. The method of producing a molding subsidiary material according to claim 9, wherein at least the outer peripheral side of the sheet material is cut into a desired shape before the overlap-bonding step.

11. The method of producing a molding subsidiary material according to claim 9, wherein the overlap-bonding is performed by sewing, pressure bonding, gluing, or fastening.

12. The method of producing a molding subsidiary material according to claim 9, wherein the overlap-bonded and molded material is provided with a magnetic material at least on an outer peripheral side.

13. The method of producing a molding subsidiary material according to claim 9, wherein the sheet material includes at least a nonwoven fabric.

14. The method of producing a molding subsidiary material according to claim 9, wherein the molded portion is formed with a through-hole or slit corresponding to an inner cavity provided in the resin body.

15. The method of producing a molding subsidiary material according to claim 14, wherein the inner cavity is a ventilation passage.

16. A molding subsidiary material comprising:
an irregular-shaped molded portion; and
an overlap-bonded portion that is formed by overlap-bonding of a notched portion and curves at least a part on an outer peripheral side,
wherein the molding subsidiary material is integrated with a resin body.

17. The molding subsidiary material according to claim 16, wherein the molded portion is provided corresponding to a concave portion or a convex portion of the resin body.

18. The molding subsidiary material according to claim 16, wherein the molded portion has a through-hole or slit corresponding to an inner cavity provided in the resin body.

19. The molding subsidiary material according to claim 16, wherein a concave portion or a convex portion of the molded portion has a width of 1 cm or more or an area of 1 cm² or more.

20. The molding subsidiary material according to claim 16, wherein
at least a part of the molded portion comprises a nonwoven fabric, and
a thickness of the part of the molded portion comprising the nonwoven fabric is 25-75% with respect to a thickness of the nonwoven fabric before molding.
